(19) United States
(12) Patent Application Publication
(10) Pub. No.: US 2007/0144814 A1
(43) Pub. Date: Jun. 28, 2007

(54) Torque sensor based steering response

(76) Inventors: Steven Don Arnold, Rancho Palos Verdes, CA (US); Randy J. Hasken, Lanark, IL (US); Soumitri N. Kolavennu, Minneapolis, MN (US); Steven J. Magee, Lena, IL (US); Tariq Samad, Minneapolis, MN (US)

Correspondence Address: Kris T. Fredrick;Honeywell International Inc., Patent Department, 101 Columbia Road, Morristown, NJ, 07962, US

(21) Appl. No.: 11/315,931

(22) Filed: Dec. 22, 2005

(51) Int. Cl. B62D 5/00

(52) U.S. Cl. 180/402

(57) ABSTRACT

Systems for active feedback and control of the steering response in a vehicle. More particularly, torque sensor based steering response systems for vehicles which allow for distinctive and customized driving feel characteristics through improved feedback of tire-surface interactions. The systems of the invention automatically translate the torque exerted on the vehicle wheels to a torque exerted on the vehicle steering wheel, achieving a human perception of a steering response as desired by the driver or as desired by the manufacturer. New advances in torque sensing based on surface acoustic waves enhance the active feedback systems of the invention with improved accuracy and reliability.

### BACKGROUND OF THE INVENTION

1. Field of the Invention

The invention relates to systems for active feedback and control of the steering response in a vehicle. More particularly, the invention pertains to torque sensor based steering response systems for vehicles which allows for distinctive and customized driving feel characteristics through improved feedback of tire-surface interactions.

2. Description of the Related Art

Automotive manufacturers seek to embody distinctive driving feel characteristics in their products. One of the more important such characteristics is related to the steering response of the vehicle. This includes the tactile communication of road feel to the steering wheel, the “resistance” offered by the wheel to steering actions, and feedback of tire-surface interactions such as loss of traction. In today's vehicles, steering feel is dependent largely on the design of the mechanical and hydraulic components in the steering subsystem. Sensors that can measure properties of interest have not traditionally been available at the price/performance point required by the automotive industry. While electrical assist is commonplace, its action is predetermined. Conventionally, steering systems are passive and not able to dynamically adapt the steering and traction performance of a vehicle to what drivers feel through their hands.

The present invention takes advantage of new surface acoustic wave torque sensing technology to provide active feedback and control of steering response to the driver. The feedback is effected through a motor, preferably a direct current (“D.C.”) torque motor that is connected to a steering input assembly. Torque sensors can be attached to both a vehicle turning mechanism, e.g. a steering box, and the steering input assembly. A torque sensor based controller can be used that takes both torque sensor measurements and positional measurements, and can output commands to a steering drive motor and the torque motor for steering wheel response. The invention can be used with both traditional power-assisted hydraulic/mechanical steering systems and modern steer-by-wire systems.

The torque sensor based controller enables the steering response for the vehicle to be designed as desired based on the “image” desired for the vehicle model, the preferences of the target market, etc. The approach can be used for passenger vehicles, light- to heavy-duty trucks, off-highway vehicles, wheeled recreational vehicles, and others. The present invention further allows for driver-adjustment of steering response. For example, the system will allow a driver to manually adjust their steering response from a torque-independent setting to a highly dynamic feedback in which the torque imparted to the steering input mechanism and influenced by the wheel (or other vehicle turning member) and road (or other medium) interactions is strongly coupled to the steering wheel torque as produced by the torque motor and the torque experienced at the steered vehicle wheels.

The present invention can also be applied to variable-ratio steering systems, allowing for a speed-sensitive steering response. In this case, the response of a given deflection of the steering wheel is a function of the vehicle speed, i.e. the vehicle wheels will turn less at higher speeds for the same steering wheel motion compared to lower speeds.

The practice of the invention is expected to be highly effective when using torque sensors incorporating surface-acoustic wave (SAW) technology. Acoustic wave sensors are notable because their detection mechanism is a mechanical, or acoustic, wave. Generally, acoustic wave devices and sensors use a piezoelectric substrate material to generate acoustic waves. Typically, piezoelectric acoustic wave sensors apply an oscillating electric field to create a mechanical wave which propagates through the substrate and is then converted back to an electric field for measurement. As the acoustic wave propagates through or on the surface of the material, any changes to the characteristics of the propagation path affect the velocity and/or amplitude of the wave. These changes in wave velocity and/or amplitude are monitored and correlated to a corresponding physical property to be measured. Surface acoustic wave sensors are sensitive to changes of many different physical parameters. SAW-based torque sensors are typically mounted on a shaft, and if the shaft experiences a torque, the torque will stress the sensor.

SAW-based torque sensing has several advantages over the state of the art, including wireless measurement, passive (un-powered) operation, as well as improved accuracy and reliability. Further, SAW-based torque sensors can directly measure the torque transmitted through an engine drive shaft without using slip rings or other contacting mechanisms. The steering response system of the present invention may be used in any type of vehicle, providing for improved control and safety during the driving experience.

### SUMMARY OF THE INVENTION

The invention provides a steering response system for a vehicle comprising:

a) a steering input assembly comprising a steering input member coupled with a steering input mechanism, which steering input assembly issues a steering input which is detected by a steering input sensor;

b) a steering input sensor connected to the steering input assembly, which steering input sensor detects the steering input from the steering input assembly and issues a steering input sensor signal corresponding to the steering input to a controller;

c) a controller connected to the steering input sensor, which controller receives a steering input sensor signal from the steering input sensor;

d) a vehicle turning assembly connected to the controller, the vehicle turning assembly comprising a vehicle turning mechanism connected to at least one vehicle turning member; wherein the controller directs an angular position of said at least one vehicle turning member responsive to the steering input sensor signal via the vehicle turning mechanism;

e) a vehicle turning sensor connected to the vehicle turning assembly and connected to the controller, which vehicle turning sensor detects a torque exerted on said vehicle turning assembly and which vehicle turning sensor transmits a vehicle turning sensor signal to said controller responsive to said torque; and

f) a torque motor connected to said controller and connected to said steering input assembly, which controller issues a torque motor signal to the torque motor responsive to said vehicle turning sensor signal, thereby causing the torque motor to exert a torque on said steering input member.

The invention also provides a steering response system for a vehicle comprising:

a) a steering input assembly comprising a steering input member coupled with a steering input mechanism;

b) a vehicle turning assembly mechanically linked to the steering input assembly, the vehicle turning assembly comprising a vehicle turning mechanism connected to at least one vehicle turning member; wherein turning the steering input member causes the vehicle turning assembly to change an angular position of said at least one vehicle turning member;

c) a vehicle turning sensor connected to the vehicle turning assembly, which vehicle turning sensor detects a torque exerted on said vehicle turning assembly, and which vehicle turning sensor transmits a vehicle turning sensor signal to a controller responsive to said torque;

d) a controller connected to the vehicle turning sensor, which controller receives the vehicle turning sensor signal transmitted from the vehicle turning sensor; and

e) a torque motor connected to said controller and connected to said steering input assembly, which controller issues a torque motor signal to the torque motor responsive to said vehicle turning sensor signal, thereby causing the torque motor to exert a torque on said steering input member.

The invention further provides a method for effecting a steering response in a vehicle comprising:

I) providing a vehicle having a steering response system which comprises:

a) a steering input assembly comprising a steering input member coupled with a steering input mechanism, which steering input assembly issues a steering input which is detected by a steering input sensor;
b) a steering input sensor connected to the steering input assembly, which steering input sensor detects the steering input from the steering input assembly and issues a steering input sensor signal corresponding to the steering input to a controller;
c) a controller connected to the steering input sensor, which controller receives a steering input sensor signal from the steering input sensor;
d) a vehicle turning assembly connected to the controller, the vehicle turning assembly comprising a vehicle turning mechanism connected to at least one vehicle turning member; wherein the controller directs an angular position of said at least one vehicle turning member responsive to the steering input sensor signal via the vehicle turning mechanism;
e) a vehicle turning sensor connected to the vehicle turning assembly and connected to the controller, which vehicle turning sensor detects a torque exerted on said vehicle turning assembly, and which vehicle turning sensor transmits a vehicle turning sensor signal to said controller responsive to said torque; and
f) a torque motor connected to said controller and connected to said steering input assembly, which controller issues a torque motor signal to the torque motor responsive to said vehicle turning sensor signal, thereby causing the torque motor to exert a torque on said steering input member;
   II) turning said steering input member resulting in a change of an angular position of said at least one vehicle turning member; and
   III) applying a torque onto said steering input member from said torque motor.

The invention still further provides a method for effecting a steering response in a vehicle comprising:

I) providing a vehicle having a steering response system which comprises:

a) a steering input assembly comprising a steering input member coupled with a steering input mechanism;
b) a vehicle turning assembly mechanically linked to the steering input assembly, the vehicle turning assembly comprising a vehicle turning mechanism connected to at least one vehicle turning member; wherein turning the steering input member causes the vehicle turning assembly to change an angular position of said at least one vehicle turning member;
c) a vehicle turning sensor connected to the vehicle turning assembly, which vehicle turning sensor detects a torque exerted on said vehicle turning assembly and transmits a vehicle turning sensor signal to a controller responsive to said torque;
d) a controller connected to the vehicle turning sensor, which controller receives the vehicle turning sensor signal transmitted from the vehicle turning sensor; and
e) a torque motor connected to said controller and connected to said steering input assembly, which controller issues a torque motor signal to the torque motor responsive to said vehicle turning sensor signal, thereby causing the torque motor to exert a torque on said steering input member;
   II) turning said steering input member resulting in a change of an angular position of said at least one vehicle turning member; and
   III) applying a torque onto said steering input member from said torque motor.

The invention also provides a method for effecting a steering response in a vehicle comprising:

I) providing a vehicle having a steering response system which comprises:

a) a steering input assembly comprising a steering input member coupled with a steering input mechanism, which steering input assembly issues a steering input which is detected by a steering input sensor;
b) a steering input sensor connected to the steering input assembly, which steering input sensor detects the steering input from the steering input assembly and issues a steering input sensor signal corresponding to the steering input to a controller;
c) a controller connected to the steering input sensor, which controller receives a steering input sensor signal from the steering input sensor;
d) a vehicle turning assembly connected to the controller, the vehicle turning assembly comprising a vehicle turning mechanism connected to at least one vehicle turning member; wherein the controller directs an angular position of said at least one vehicle turning member responsive to the steering input sensor signal via the vehicle turning mechanism;
e) a vehicle turning sensor connected to the vehicle turning assembly and connected to the controller, which vehicle turning sensor detects a torque exerted on said vehicle turning assembly, and which vehicle turning sensor transmits a vehicle turning sensor signal to said controller responsive to said torque; and
f) a torque motor connected to said controller and connected to said steering input assembly, which controller issues a torque motor signal to the torque motor responsive to said vehicle turning sensor signal, thereby causing the torque motor to exert a torque on said steering input member;
   II) effecting a steering input via the steering input assembly;
   III) causing the steering input sensor to detect the steering input from the steering input assembly and issue a steering input sensor signal corresponding to the steering input to the controller;
   IV) causing the controller to receive a steering input sensor signal from the steering input sensor;
   V) causing the controller to direct the vehicle turning assembly to direct an angular position of said at least one vehicle turning member responsive to the steering input sensor signal;
   VI) causing the vehicle turning sensor to detect a torque exerted on said at least one vehicle turning member and transmitting a corresponding vehicle turning sensor signal to said controller; and
   VII) causing the controller to issue a torque motor signal to the torque motor thereby responsive to said vehicle turning sensor signal, causing the torque motor to exert a torque on said steering input member.

### BRIEF DESCRIPTION OF THE DRAWINGS

FIG. 1 is a block diagram illustrating a mechanical steering response system of the invention.

FIG. 2 is a block diagram illustrating a steer-by-wire steering response system of the invention.

FIG. 3 is a block diagram illustrating a mechanical steering response system of the prior art.

FIG. 4 is a block diagram illustrating a steer-by-wire steering response system of the prior art.

### DETAILED DESCRIPTION OF THE INVENTION

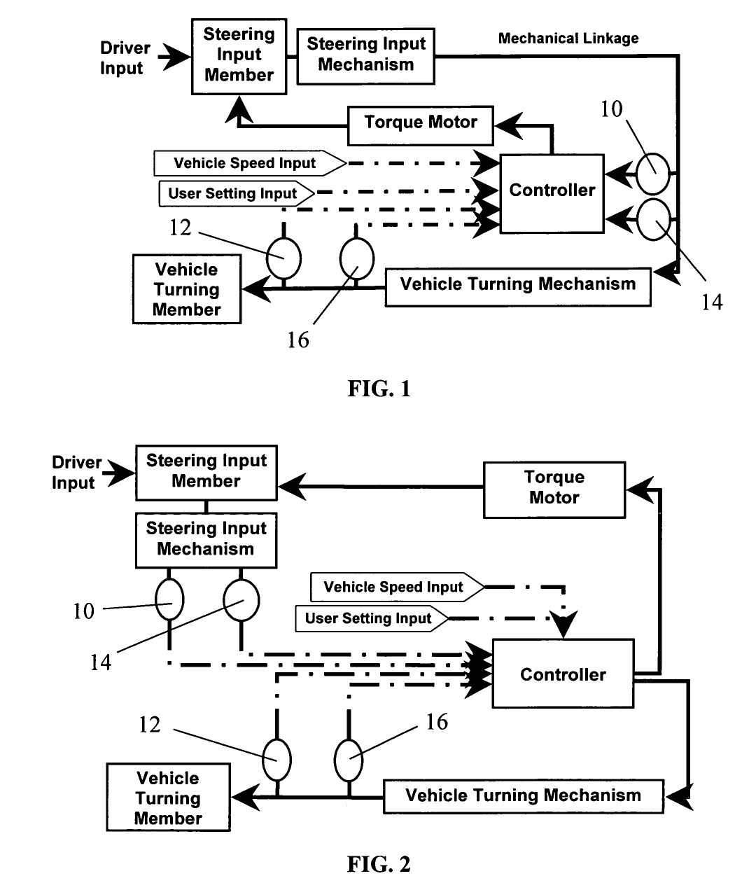

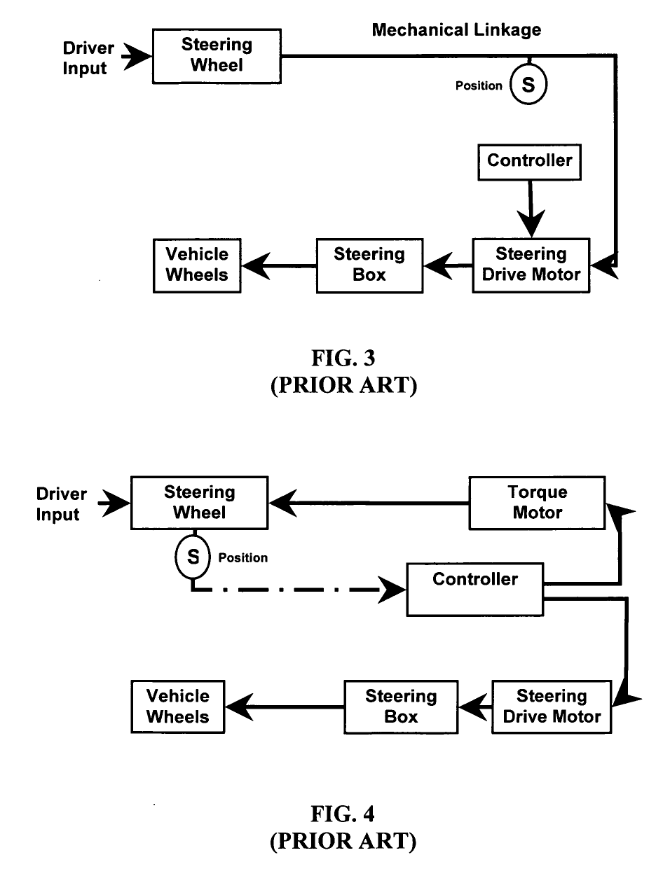

The steering response systems of the invention incorporate one or more sensors which detect forces that are exerted on a vehicle, and communicate these forces to a controller which is programmed to automate a driver feedback responsive to said forces. As used herein, the term “vehicle” is intended to include any type of man-made means of steered transport, including cars, trucks, motorcycles, mopeds, wheelchairs, trains, tanks, aircraft, watercraft and the like. The steering response systems of the invention are useful with practically all steering designs, including traditional mechanical rack-and-pinion systems, as well as modern steer-by-wire systems. Mechanical designs may include non-power assisted mechanical systems or power assisted mechanical systems, such as power assisted hydraulic systems. FIGS. 1 and 2 are block diagrams illustrating the basic elements of the steering response systems of the present invention. FIG. 1 illustrates a mechanical steering response system of the invention, while FIG. 2 illustrates a steer-by-wire steering response system of the invention. These are compared to FIGS. 3 and 4 which illustrate steering systems of the prior art that do not have active feedback and steering response control capabilities as provided herein.

In the mechanical system of FIG. 1, a steering input member is coupled with a steering input mechanism. Generally, the steering input member comprises a steering wheel, and the steering input mechanism comprises a rotatable steering shaft, as is conventionally known in the art. A steering input member as used herein may alternately comprise another device suitable for steering a vehicle, such as a joystick or other member suitable for both exerting a steering input and receiving a resulting feedback. Additionally, the steering input mechanism may comprise an alternate structure to a steering shaft that can be suitably enabled to effect the steering of the vehicle as is intended. Together, the steering input member and steering input mechanism comprise what is referred to herein as a “steering input assembly”.

The steering input assembly is mechanically linked to a vehicle turning mechanism, which vehicle turning mechanism is connected to at least one vehicle turning member. Generally, the at least one vehicle turning member comprises at least one vehicle wheel, and the vehicle turning mechanism comprises the steering box, gears and other structures necessary to connect the steering input assembly to the vehicle turning member or members as is conventionally known in the art. A vehicle turning member may alternately comprise another device suitable for turning a vehicle, such as a rudder of an aircraft or watercraft. Together, the vehicle turning mechanism and the at least one vehicle turning member comprise what is referred to herein as a “vehicle turning assembly”. In this embodiment, the mechanical linkage of the vehicle turning assembly and the steering input assembly enables a driver input, e.g. a turning of the steering input member, to cause the vehicle turning assembly to change an angular position of said at least one vehicle turning member.

The mechanical steering response system of the invention further includes a vehicle turning sensor 12 connected to the vehicle turning assembly, a torque motor connected to said steering input assembly, and a controller connected to each of said vehicle turning sensor and said torque motor. The vehicle turning sensor 12 detects a torque exerted on the vehicle turning assembly and transmits a vehicle turning sensor signal to a controller responsive to said torque. The controller processes this vehicle turning sensor signal and accordingly issues a corresponding torque motor signal to the torque motor thereby causing the torque motor to exert a torque on said steering input member. In this case, the controller and torque motor can operate in parallel with the mechanical system. The controller is preferably electrically connected to both the torque motor and the vehicle turning assembly (typically the vehicle turning mechanism).

As stated above, the steering response systems of the invention are useful with virtually any steering design. Currently, rack-and-pinion steering is the most common type of mechanical steering system for cars, small trucks and SUVs. In a general rack-and-pinion system, a steering wheel is connected to a steering shaft, and a pinion gear is attached to the opposite end of the steering shaft. The pinion gear is connected to a rack, and tie rods are connected to each end of the rack. As the steering wheel is turned, the pinion gear spins, moving the rack. The tie rod at each end of the rack connects to a wheel through steering arm and a spindle. For the purposes of this invention, a “steering input mechanism” describes the structural or electrical components that connect the steering wheel to either the vehicle turning assembly or to the controller. For example, the “steering input mechanism” would include the steering shaft, or an electrical connection between the steering wheel and the controller. As used herein, a “vehicle wheel turning mechanism” describes the structural or electrical components connecting the vehicle wheels to either the steering input assembly or the controller. For example, the “vehicle wheel turning mechanism” would encompass the pinion gear, rack, tie rods, steering arms and spindles in a general rack-and-pinion system. The collective unit of gears is sometimes referred to in the art as a “steering box”.

Another conventional type of mechanical steering system is the recirculating-ball steering system. In this system, the steering wheel is connected to a recirculating-ball steering gear, which recirculating-ball steering gear contains a worm gear that is connected to a pitman arm. A worm gear consists of a shaft with a screw thread, i.e. the worm, that meshes with a toothed wheel, i.e. the worm wheel. The steering shaft is connected to the worm and the worm wheel engages the pitman arm. When the steering wheel turns, it turns the worm which moves the worm wheel, which moves the gear that turns the wheels. Instead of the worm directly engaging threads inside the worm wheel, the threads are filled with ball bearings that recirculate through the gear as it turns. This reduces friction, wear and slop in the gear.

As is well known in the art, mechanical systems such as rack-and-pinion or recirculating ball systems may also be power assisted using slightly different designs, such as hydraulic systems including high pressure fluids. The steering response systems of the present invention are applicable to any type of steering system, power assisted or non-power assisted.

As illustrated in FIG. 2, the steering response systems of the invention are also useful in modern steer-by-wire systems. A steer-by-wire system, also known as a drive-by-wire system, eliminates the mechanical connection between the steering input member and the vehicle turning assembly, replacing it with a purely electronic control system. This type of system generally requires additional components. Particularly, a steer-by-wire steering response system of the invention includes a steering input sensor 10 connected to the steering input assembly and connected to a controller. This steering input sensor detects a steering input from the steering input assembly and issues a corresponding steering input sensor signal to the controller. Although not required, a mechanical steering system may also further comprise a steering input sensor connected to the steering input assembly and electrically connected to the controller, which sensor detects a steering input from the steering input assembly and issues a steering input sensor signal corresponding to the steering input to the controller. In such an embodiment, the steering input sensor would preferably comprise a position sensor, and would preferably be attached to the rotatable steering shaft.

In contrast to the afore described mechanical system, the controller in a steer-by-wire system of the invention is further connected to a vehicle turning assembly. Upon receipt of the steering input sensor signal, the controller communicates with the vehicle turning assembly to direct an angular position of at least one vehicle turning member responsive to the steering input sensor signal via the vehicle turning mechanism. Due to the absence of a mechanical linkage between the steering input assembly and the vehicle turning assembly, the vehicle turning assembly in a steer-by-wire system utilizes a steering drive motor to direct the angular position of the at least one vehicle turning member. Any steering drive motor as conventionally known in the art is suitable and could be readily selected by one skilled in the art. Similar to above, a vehicle turning sensor 12 connected to the vehicle turning assembly and connected to the controller detects a torque exerted on said vehicle turning assembly and transmits a vehicle turning sensor signal to said controller responsive to said torque. A torque motor is connected to the controller and connected to the steering input assembly, and the controller issues a torque motor signal to the torque motor responsive to said vehicle turning sensor signal, thereby causing the torque motor to exert a torque on said steering input member.

In the preferred embodiments of the invention, the vehicle turning sensor preferably comprises a torque sensor, particularly a surface acoustic wave (SAW) sensor. As discussed above, SAW sensors allow for wireless measurement and un-powered operation, and can directly measure torque without using traditional slip rings or other contacting mechanisms. SAW-based torque sensors are typically mounted on a shaft, and if the shaft experiences a torque, the torque will stress the sensor. Torque sensor 12 is preferably attached to a torque-bearing shaft or other suitable element of the vehicle turning mechanism (e.g. within a steering box), and thereby detects the torque that exists between the turning mechanism and the vehicle turning members, e.g. the wheels. Such placement would be readily determined by one skilled in the art. The torque detected by torque sensor 12 is a result of the vehicle turning mechanism applying a control input and the wheels and surface (e.g. the road) resisting as well as the continuously changing road traction, vehicle momentum, etc. Other conventionally known types of torque sensors may be used, but SAW-based sensors are the most preferred.

In the preferred embodiments of the invention, the steering input sensor 10 preferably comprises a position sensor capable of taking positional measurements, and may be attached to a rotatable or non-rotatable steering shaft or other element of the steering input mechanism from which it can detect a steering input. Such placement would be readily determined by one skilled in the art. Steering input sensor 10 may generally comprise a variety of digital and/or analog position sensors as are well known in the art, including proximity type position sensors, vane and gear-tooth position sensors, magnet position sensors, magnetoresistive digital sensors, solid-state basic switch sensors, and Hall-effect position sensors, such as Hall-effect vane sensors, Hall-effect rotary position sensors and Hall-effect basic switch sensors. Preferred position sensors are commercially available from Honeywell International Inc., of Morristown, N.J.

As illustrated in each of FIG. 1 and FIG. 2, the steering response systems of the present invention may optionally further include additional sensors to provide the desired active feedback and control of a steering response to the vehicle driver. For example, an additional torque sensor 14, preferably a SAW-based torque sensor, can be attached to the steering input assembly, and an additional position sensor 16 can be attached to the vehicle turning assembly. If an additional torque sensor 14 is present, the controller directs the vehicle turning assembly to change an angular position of the at least one vehicle turning member responsive to both said steering torque sensor signal and the steering input sensor signal. If an additional position sensor 16 is present, the controller issues a torque motor signal to the torque motor thereby causing the torque motor to exert a torque on said steering input member responsive to both said position sensor signal and said vehicle turning sensor signal. Each of sensors 10 and 12, as well as additional sensors 14 and 16, are either wirelessly or electrically connected to the controller. Additional torque and position sensors may be further included as may be desired by one skilled in the art. In the preferred embodiments of the invention, the controller in each steering system issues a torque motor signal to the torque motor which is additionally responsive to the steering input sensor signal from the steering input sensor, thereby causing the torque motor to exert a torque on said steering input member. In other words, the controller signal issued would be responsive to the steering input signal in addition to the vehicle turning sensor signal.

Further, the controller preferably simultaneously receives signals from each of said steering input sensor and vehicle turning sensor and outputs signals to said vehicle turning assembly and said torque motor, each of these output signals being responsive to both of the received signals. In this embodiment the controller is a true multivariable controller.

In the preferred embodiments of the invention, the torque motor preferably comprises a direct current torque motor. Suitable direct current torque motors are commercially available. Other suitable motor types could be readily determined by one skilled in the art. The torque motor is preferably electrically connected to the controller. All steering mechanisms have an automatic recentering feature so that the wheel returns to the neutral position in the absence of driver-supplied torque to it. The recentering is achieved mechanically in traditional systems and through the controller and torque motor in steer-by-wire systems. Appropriate safeguards must be provided to ensure that the provided torque applied by the torque motor stays within safety limits. For example, it is important that the torque motor cannot overcome driver resistance and force recentering.

In the preferred embodiments of the invention, the steering response system further includes a vehicle speed input mechanism connected to the controller which transmits a vehicle speed input signal to the controller, whereby the controller issues a torque motor signal to the torque motor thereby causing the torque motor to exert a torque on the steering input member responsive to both the vehicle speed input signal and the vehicle turning sensor signal. Analogously, for steer-by-wire systems, the incorporation of the vehicle speed input signal as an additional input to the controller will enable the controller to direct the angular positions of one or more vehicle turning members in a way that is responsive additionally to the vehicle speed input signal. This allows for a speed-sensitive steering response. More particularly, the vehicle speed input allows the response of a given deflection of the steering wheel to be a function of the vehicle speed, i.e. the vehicle wheels will turn less at higher speeds for the same steering wheel motion compared to lower speeds. This enhances the safety of the steering response systems of the invention, and improves their functionality. The vehicle speed input mechanism preferably comprises a standard mechanism conventionally present in vehicles.

The steering response system also further includes a user setting input mechanism connected to the controller. This optional user setting input mechanism transmits a user setting input signal to the controller, whereby the controller issues a torque motor signal to the torque motor thereby causing the torque motor to exert a torque on the steering input member responsive to both said user setting input signal and said vehicle turning sensor signal. This optional user setting input allows the driver or vehicle manufacturer to adjust the steering response as they desire. For example, as described above, the driver or manufacturer can adjust the steering response from a torque-independent setting, such as in the prior art systems illustrated in FIG. 3 and FIG. 4, to a highly dynamic feedback in which the torque imparted to the steering input assembly, and influenced by the wheel (or other vehicle turning member) and road (or other medium) interactions, is strongly coupled to the torque experienced at the steered wheels. The user setting input mechanism may comprise a simple knob, slider, touch screen display, or other suitable mechanism as determined by one skilled in the art.

Additionally, diagnostic information can be communicated within the steering response systems of the invention. For example, sensor dropouts and other anomalies can be captured and diagnostic codes set and communicated to other components of the electronic architecture. The diagnostic information communication could be readily factored into the controller software by one skilled in the art.

At the heart of the steering response systems of the invention is the controller. Each of the elements described above which are connected to the controller are connected, such as by wired or wireless means, so that the controller commands their functioning. The controller preferably comprises a proportional-integral controller (PI controller), a proportional-integral derivative controller (PID controller), a model-based controller, or another suitable controller that allows for multivariable control, i.e. enabling the calculation of controller outputs to the torque motor and the vehicle turning assembly to be responsive to both the steering input sensor signal and the vehicle turning sensor signal, along with signals from any other incorporated sensors, in each of the described steering response system embodiments. Particularly, the controller output signals are preferably responsive to a combination of all position and torque sensor signals, in addition to optional vehicle speed input signals and user setting input signals. In addition, the calculation of these two controller outputs are preferably be done jointly, not separately. Such suitable controllers are well known in the art.

The controller can be programmed and designed in various ways. For example, a function can be defined that maps torque and position sensor signals to the D.C. torque motor torque command. This mapping can be linear or nonlinear, fixed by the manufacturer or adjustable by the vehicle operator. Many different functions can be used. Instead of a functional mapping, dynamics can be included so that the controller output is based not only on the instantaneous torque and position signals but on some number of past samples of these signals as well.

The controller includes software that implements the computational logic for determining input signals to the D.C. torque motor and, if present, the steering drive motor. This logic can implemented in many ways. In the simplest case the controller operation can be represented as:
u=f(y,p)
where y represents the vector of outputs from the steering system to the controller (y is also referred to as the controller input), including steering input position sensor 10 output, steering input torque sensor 14 output, vehicle turning torque sensor 12 output, vehicle turning position sensor 16 output, and, where used, the user setting and vehicle speed inputs; and u represents the input signals from the controller to the torque motor and the optional steering drive motor (u is also referred to as the controller output). The vector p can be used to explicitly represent parameters associated with the controller or the steering system so that the calculation can take these into account.

With such a functional form, the controller outputs are functions of current (or recent) inputs; the controller does not have dynamic state. This can limit performance in some cases. A technically superior alternative is to incorporate dynamics in the controller. This can be represented in the following form:
x[k+1]=f(x[k], y[k], p[k]); x[0]=x₀
u[k+1]=g(x[k], y[k], p[k])
where x[k] represents the controller state vector at time k, x₀ is the initial controller state, y[k] represents the vector of external inputs to the controller, and u[k] is the controller output vector. The state vector can be used to retain past values of inputs and computed outputs as well as derived variables.

The details of the vector functions f(.) and g(.) above will be influenced by the design and implementation of the controller, but the implemented controller can be represented with explicit functions as noted.

Preferred is a supervisory/PI controller combination as described by the following formulation:
u[k+1]=k_{c}e[k]+kᵢeₛᵤₘ[k]
eₛᵤₘ[k+1]=eₛᵤₘ[k]+e[k]; eₛᵤₘ[0]=0
e[k]=y_{PI,r}[k]−y_{PI}[k]
y_{PI,r}[k]=h(y[k], p_{y}[k])
y_{PI}[k]=s(y[k])

A PI controller is a device which controls the input of a system proportional to its output. Here k_{c} and kᵢ are 2-vectors of controller parameters (referred to as proportional and integral gains respectively), e[k] and eₛᵤₘ[k] are instantaneous and integrated error signals (also 2-vectors in this formulation) between internally computed reference outputs and measured outputs for the PI controller (these outputs can be a subset of the output vector y), p_{y} are additional parameters for the controller, h(.) is a function that calculates the reference output based on the output vector, and s(.) selects the particular elements of y that are used to drive the PI controllers.

Another alternative is an online optimization or search in which the controller implements a solution algorithm with an optimization criterion and constraints. An example of this is a model-based or model-predictive controller in which a model of the system to be controlled is essentially embedded (explicitly or implicitly) in the controller calculation:

$$u [ k ] = {arg min}_{u} J ( {x}_{s} , u , y , p )$$

subject to
xₛ[k+1]=fₛ(xₛ[k], u[k])
y[k+1]=gₛ(xₛ[k], u[k])
v(xₛ, y, u, p)=0
w(xₛ, y, u, p)>0

Here J(.) is the optimization criterion for the controller; the controller output at time k is the value of u that minimizes this criterion while respecting constraints associated with the dynamics of the controlled system and equality and inequality constraints associated with the inputs, outputs, and parameters. The vector xₛ here is the state vector for the model of the controlled system (the steering system); fₛ and gₛ are the state and output equations comprising the model of the steering system (with inputs u and outputs y).

Other formulations of the controller calculation are possible within the scope of the invention. These other formulations include linear quadratic regulators (LQR), pole-placement controllers, sliding mode controllers, feedback linearization controllers, dynamic inversion controllers, H-infinity controllers, adaptive controllers, robust controllers, and others. The formulations above are intended simply to exemplify the kinds of controller calculations that are covered by this invention.

The systems of the present invention thereby automatically translate the torque exerted on the vehicle wheels (or other vehicle turning member) to a torque exerted on the vehicle steering wheel (or other steering input member), achieving a human perception of a steering response as desired by the driver or as desired by the manufacturer. Importantly, new advances in torque sensing based on surface acoustic waves enhance the active feedback systems of the invention with improved accuracy and reliability.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A steering response system for a vehicle comprising:
a) a steering input assembly comprising a steering input member coupled with a steering input mechanism, which steering input assembly issues a steering input which is detected by a steering input sensor;
b) a steering input sensor connected to the steering input assembly, which steering input sensor detects the steering input from the steering input assembly and issues a steering input sensor signal corresponding to the steering input to a controller;
c) a controller connected to the steering input sensor, which controller receives a steering input sensor signal from the steering input sensor;
d) a vehicle turning assembly connected to the controller, the vehicle turning assembly comprising a vehicle turning mechanism connected to at least one vehicle turning member; wherein the controller directs an angular position of said at least one vehicle turning member responsive to the steering input sensor signal via the vehicle turning mechanism;
e) a vehicle turning sensor connected to the vehicle turning assembly and connected to the controller, which vehicle turning sensor detects a torque exerted on said vehicle turning assembly and which vehicle turning sensor transmits a vehicle turning sensor signal to said controller responsive to said torque; and
f) a torque motor connected to said controller and connected to said steering input assembly, which controller issues a torque motor signal to the torque motor responsive to said vehicle turning sensor signal, thereby causing the torque motor to exert a torque on said steering input member.

2. The steering response system of claim 1 wherein said controller receives signals from each of said steering input sensor and vehicle turning sensor and outputs signals to said vehicle turning assembly and said torque motor, wherein each of said output signals is responsive to both of said received signals.

3. The steering response system of claim 1 wherein said steering input sensor comprises a position sensor.

4. The steering response system of claim 1 wherein said vehicle turning sensor comprises a surface acoustic wave torque sensor.

5. The steering response system of claim 1 further comprising a vehicle speed input mechanism connected to said controller and which transmits a vehicle speed input signal to said controller, and which controller issues a torque motor signal to the torque motor thereby causing the torque motor to exert a torque on said steering input member responsive to both said vehicle speed input signal and said vehicle turning sensor signal.

6. The steering response system of claim 1 further comprising a user setting input mechanism connected to said controller which transmits a user setting input signal to said controller, and which controller issues a torque motor signal to the torque motor thereby causing the torque motor to exert a torque on said steering input member responsive to both said user setting input signal and said vehicle turning sensor signal.

7. The steering response system of claim 1 further comprising a position sensor connected to the vehicle turning assembly and connected to the controller, which position sensor detects a position movement of said at least one vehicle turning member and transmits a corresponding position signal to said controller and which controller issues a torque motor signal to the torque motor thereby causing the torque motor to exert a torque on said steering input member responsive to said position sensor signal.

8. The steering response system of claim 1 further comprising a torque sensor connected to the steering input assembly and connected to the controller, which torque sensor detects a torque exerted on said steering input assembly and transmits a corresponding steering torque signal to said controller and which controller receives the steering torque signal and wherein the controller directs the vehicle turning assembly to change an angular position of said at least one vehicle turning member responsive to said steering torque sensor signal and the steering input sensor signal.

9. The steering response system of claim 1 wherein said controller comprises a proportional-integral controller, a proportional-integral derivative controller or a model-based controller.

10. A steering response system for a vehicle comprising:
a) a steering input assembly comprising a steering input member coupled with a steering input mechanism;
b) a vehicle turning assembly mechanically linked to the steering input assembly, the vehicle turning assembly comprising a vehicle turning mechanism connected to at least one vehicle turning member; wherein turning the steering input member causes the vehicle turning assembly to change an angular position of said at least one vehicle turning member;
c) a vehicle turning sensor connected to the vehicle turning assembly, which vehicle turning sensor detects a torque exerted on said vehicle turning assembly, and which vehicle turning sensor transmits a vehicle turning sensor signal to a controller responsive to said torque;
d) a controller connected to the vehicle turning sensor, which controller receives the vehicle turning sensor signal transmitted from the vehicle turning sensor; and
e) a torque motor connected to said controller and connected to said steering input assembly, which controller issues a torque motor signal to the torque motor responsive to said vehicle turning sensor signal, thereby causing the torque motor to exert a torque on said steering input member.

11. The steering response system of claim 10 further comprising a steering input sensor connected to the steering input assembly and electrically connected to the controller, which sensor detects a steering input from the steering input assembly and issues a steering input sensor signal corresponding to the steering input to the controller, wherein said steering input sensor comprises a position sensor.

12. The steering response system of claim 11 wherein said controller receives signals from each of said steering input sensor and vehicle turning sensor and outputs signals to said vehicle turning assembly and said torque motor, wherein each of said output signals is responsive to both of said received signals.

13. The steering response system of claim 10 wherein said vehicle turning sensor comprises a surface acoustic wave torque sensor.

14. The steering response system of claim 10 further comprising a vehicle speed input mechanism connected to said controller and which transmits a vehicle speed input signal to said controller, and which controller issues a torque motor signal to the torque motor thereby causing the torque motor to exert a torque on said steering input member responsive to both said vehicle speed input signal and said vehicle turning sensor signal.

15. The steering response system of claim 10 further comprising a user setting input mechanism connected to said controller which transmits a user setting input signal to said controller, and which controller issues a torque motor signal to the torque motor thereby causing the torque motor to exert a torque on said steering input member responsive to both said user setting input signal and said vehicle turning sensor signal.

16. The steering response system of claim 10 further comprising a position sensor connected to the vehicle turning assembly and connected to the controller, which position sensor detects a position movement of said at least one vehicle turning member and transmits a corresponding position signal to said controller and which controller issues a torque motor signal to the torque motor thereby causing the torque motor to exert a torque on said steering input member responsive to said position sensor signal.

17. The steering response system of claim 10 further comprising a torque sensor connected to the steering input assembly and connected to the controller, which torque sensor detects a torque exerted on said steering input assembly and transmits a corresponding steering torque signal to said controller and which controller receives the steering torque signal and wherein the controller directs the vehicle turning assembly to change an angular position of said at least one vehicle turning member responsive to said steering torque sensor signal and the steering input sensor signal.

18. The steering response system of claim 10 wherein said controller comprises a proportional-integral controller, a proportional-integral derivative controller or a model-based controller.

19. A method for effecting a steering response in a vehicle comprising:
I) providing a vehicle having a steering response system which comprises:
a) a steering input assembly comprising a steering input member coupled with a steering input mechanism, which steering input assembly issues a steering input which is detected by a steering input sensor;
b) a steering input sensor connected to the steering input assembly, which steering input sensor detects the steering input from the steering input assembly and issues a steering input sensor signal corresponding to the steering input to a controller;
c) a controller connected to the steering input sensor, which controller receives a steering input sensor signal from the steering input sensor;
d) a vehicle turning assembly connected to the controller, the vehicle turning assembly comprising a vehicle turning mechanism connected to at least one vehicle turning member; wherein the controller directs an angular position of said at least one vehicle turning member responsive to the steering input sensor signal via the vehicle turning mechanism;
e) a vehicle turning sensor connected to the vehicle turning assembly and connected to the controller, which vehicle turning sensor detects a torque exerted on said vehicle turning assembly, and which vehicle turning sensor transmits a vehicle turning sensor signal to said controller responsive to said torque; and
f) a torque motor connected to said controller and connected to said steering input assembly, which controller issues a torque motor signal to the torque motor responsive to said vehicle turning sensor signal, thereby causing the torque motor to exert a torque on said steering input member;
II) turning said steering input member resulting in a change of an angular position of said at least one vehicle turning member; and
III) applying a torque onto said steering input member from said torque motor.

20. A method for effecting a steering response in a vehicle comprising:
I) providing a vehicle having a steering response system which comprises:
a) a steering input assembly comprising a steering input member coupled with a steering input mechanism;
b) a vehicle turning assembly mechanically linked to the steering input assembly, the vehicle turning assembly comprising a vehicle turning mechanism connected to at least one vehicle turning member; wherein turning the steering input member causes the vehicle turning assembly to change an angular position of said at least one vehicle turning member;
c) a vehicle turning sensor connected to the vehicle turning assembly, which vehicle turning sensor detects a torque exerted on said vehicle turning assembly and transmits a vehicle turning sensor signal to a controller responsive to said torque;
d) a controller connected to the vehicle turning sensor, which controller receives the vehicle turning sensor signal transmitted from the vehicle turning sensor; and
e) a torque motor connected to said controller and connected to said steering input assembly, which controller issues a torque motor signal to the torque motor responsive to said vehicle turning sensor signal, thereby causing the torque motor to exert a torque on said steering input member;
II) turning said steering input member resulting in a change of an angular position of said at least one vehicle turning member; and
III) applying a torque onto said steering input member from said torque motor.
